(19) United States
(12) Patent Application Publication
(10) Pub. No.: US 2025/0166510 A1
(43) Pub. Date: May 22, 2025

(54) Blind Spot Estimation Device, Traveling Environment Generation Device, Vehicle Control Device, and Vehicle

(71) Applicant: Hitachi, Ltd., Tokyo (JP)

(72) Inventors: Takahiro SAKAI, Tokyo (JP); Teppei SAITO, Tokyo (JP)

(21) Appl. No.: 18/937,843

(22) Filed: Nov. 5, 2024

(30) Foreign Application Priority Data
Nov. 17, 2023 (JP) 2023-195594

(51) Int. Cl. G08G 1/16; G08G 1/0967

(52) U.S. Cl. CPC G08G 1/167; G08G 1/096725; G08G 1/166

(57) ABSTRACT

A blind spot in an observation area of a vehicle is estimated. Provided is a device for estimating a blind spot in an observation area of a vehicle that performs autonomous driving on the basis of data acquired by sensing the observation area. The blind spot estimation device includes an operation route generation unit that calculates an operation route of the vehicle, an observation area switching position calculation unit that calculates an observation area switching position at which the observation area is switched from a first observation area to a second observation area when the operation route intersects with a travel route of another moving body, an observation area calculation unit that calculates the second observation area, a scenario generation unit that generates a plurality of evaluation scenarios that are different in environmental condition for the operation route, a recognition determination unit that determines a success or failure of recognition of the other moving body in the second observation area by simulating a sensing of the second observation area by a sensor mounted to the vehicle according to the respective evaluation scenarios, and a risk map generation unit that aggregates results of the success or failure of recognition for the plurality of evaluation scenarios and generates a risk map indicating a blind spot in the second observation area superimposed on the second observation area.

### CROSS-REFERENCE TO RELATED APPLICATION

This application claims priority to Japanese Patent Application No. 2023-195594 filed on Nov. 17, 2023, the entire contents of which are incorporated by reference herein.

### BACKGROUND

This invention relates to a blind spot estimation device, a traveling environment generation device, a vehicle control device, and a vehicle.

In autonomous driving, a sensor mounted to a vehicle senses an observation area that needs to be watched from the vehicle to determine an existence of another vehicle and the like, and the vehicle is controlled on the basis of data acquired by the sensor. Therefore, it is necessary to appropriately set the area that the sensor senses so as to cause the sensor mounted to the vehicle to appropriately sense the observation area of the vehicle.

As a technique for setting a detection area of a sensor mounted to a vehicle, Japanese Unexamined Patent Application Publication No. 2011-253241 has been known. Japanese Unexamined Patent Application Publication No. 2011-253241 describes that “the radar device 11 operates by switching an operation mode to any mode of a viewing angle priority mode or a distance priority mode corresponding to an instruction from the ECU 13. The viewing angle priority mode is, for example, as illustrated in FIG. 2, a mode of detecting an object in a detection area SA1 having a relatively short maximum detection distance and a relatively wide viewing angle in horizontal direction” in paragraph 0031, and describes that “the distance priority mode is, for example, as illustrated in FIG. 3, a mode of detecting an object in a detection area SA2 having a relatively long maximum detection distance and a relatively narrow viewing angle in horizontal direction” in paragraph 0032.

Then, for the process executed by the ECU 13 that controls the radar device 11, it is described that, in paragraph 0041, “the ECU 13 advances the process to Step S3 when it is determined that an intersection or a curve is present ahead of the subject vehicle 100. On the other hand, the ECU 13 advances the process to Step S5 when it is determined that there is no intersection or curve ahead of the subject vehicle 100” and it is described that, in paragraph 0042, “in Step S3, the ECU 13 determines whether or not the other vehicle position has been acquired . . . . The ECU 13 advances the process to Step S4 when it is determined that the other vehicle position has been acquired, and meanwhile, the ECU 13 advances the process to Step S5 when it is determined that the other vehicle position has not been acquired”. Further, it is described that “in Step S4, the ECU 13 sets the radar device 11 to the distance priority mode” in paragraph 0043, and it is described that “in Step S5, the ECU 13 sets the radar device 11 to the viewing angle priority mode” in paragraph 0044.

### SUMMARY

Even when the detection area of the sensor is set as described in Japanese Unexamined Patent Application Publication No. 2011-253241, a blind spot appears within the detection area of the sensor depending on the weather and time of day in some cases. Then, when the blind spot in the detection area of the sensor overlaps with the observation area of the vehicle, the blind spot appears also in the observation area of the vehicle. When such a blind spot can be estimated, for example, by installing an infrastructure sensor in an environment so as to allow sensing the blind spot, the blind spot can be complemented, thus leading to the improvement of safety of autonomous driving.

Therefore, it is an object of the present invention to provide a blind spot estimation device, a traveling environment generation device, a vehicle control device, and a vehicle that estimate a blind spot in an observation area of the vehicle.

A blind spot estimation device of the present disclosure is configured to, for example, set an observation area and estimate a blind spot in the observation area of a vehicle that performs autonomous driving on the basis of data acquired by sensing the observation area by a sensor, and the blind spot estimation device includes: an operation route generation unit that calculates an operation route to a destination of the vehicle; an observation area switching position calculation unit that calculates an observation area switching position at which the observation area is switched from a first observation area to a second observation area when the operation route intersects with a travel route of other moving body; an observation area calculation unit that calculates the second observation area corresponding to the observation area switching position; a scenario generation unit that generates a plurality of evaluation scenarios that are different in a predetermined environmental condition for the operation route; a recognition determination unit that determines a success or failure of recognition of the other moving body positioned in the second observation area by simulating a sensing of the second observation area by a sensor mounted to the vehicle under the environmental condition for each of the evaluation scenarios; and a risk map generation unit that aggregates results of the success or failure of recognition of the other moving body in the second observation area for the plurality of evaluation scenarios and generates a risk map indicating a blind spot in the second observation area superimposed on the second observation area.

A traveling environment generation device of the present disclosure is configured to, for example, set an observation area and estimate a blind spot in the observation area of a vehicle that performs autonomous driving on the basis of data acquired by sensing the observation area by a sensor, and the traveling environment generation device includes: an operation route generation unit that calculates an operation route to a destination of the vehicle; an observation area switching position calculation unit that calculates an observation area switching position at which the observation area is switched from a first observation area to a second observation area when the operation route intersects with a travel route of other moving body; an observation area calculation unit that calculates the second observation area corresponding to the observation area switching position; a risk map generation unit that generates a risk map indicating a state of observation of a surrounding environment by the vehicle from sensing data by a sensor mounted to the vehicle; and a blind spot drawing unit that displays the risk map with the second observation area superimposed thereon.

A vehicle control device of the present disclosure controls the vehicle according to the operation route, the observation area switching position, and the observation area calculated by the blind spot estimation device, for example.

A vehicle of the present disclosure includes the vehicle control device, for example.

According to the present invention, it is possible to provide a blind spot estimation device, a traveling environment generation device, a vehicle control device, and a vehicle that estimate a blind spot in an observation area of the vehicle. Other problems and novel feature will be apparent from the description of the present specification and appended drawings.

### BRIEF DESCRIPTION OF THE DRAWINGS

FIG. 1 is a diagram illustrating a configuration of a blind spot estimation device according to a first embodiment.

FIG. 2 is a diagram for describing road information.

FIG. 3 is a diagram for describing a three-dimensional map.

FIG. 4 is a diagram illustrating a flowchart of a process by the blind spot estimation device.

FIG. 5 is diagram illustrating a flowchart of Step S104.

FIG. 6 is a diagram illustrating an example of road information and operation route.

FIG. 7 is a diagram for describing a second observation area in a case of turning right at an intersection.

FIG. 8 is a diagram for describing the second observation area in a case of turning left at an intersection.

FIG. 9 is a diagram for describing the second observation area in a case of turning right at a T-junction without a traffic light.

FIG. 10 is a diagram for describing the second observation area in a case of turning left at a T-junction without a traffic light.

FIG. 11 is a diagram illustrating a flowchart of Step S105.

FIG. 12 is a diagram illustrating a flowchart of Step S106.

FIG. 13A is a diagram illustrating a first observation area switching position and the second observation area in a case of turning right at an intersection.

FIG. 13B is a diagram illustrating an example of a risk map corresponding to the second observation area illustrated in FIG. 13A.

FIG. 14A is a diagram illustrating a second observation area switching position and the second observation area in a case of turning right at an intersection.

FIG. 14B is a diagram illustrating an example of a risk map corresponding to the second observation area illustrated in FIG. 14A.

FIG. 14C is a diagram illustrating an example of a risk map updated on the basis of an evaluation scenario in which an operation route is the same and the weather is different.

FIG. 15 is a diagram illustrating a configuration of a blind spot estimation device according to a second embodiment.

FIG. 16 is a diagram illustrating an example of sensor information of an infrastructure sensor.

FIG. 17 is a diagram illustrating a flowchart of a process by an infrastructure sensor arrangement calculation unit.

FIG. 18A is a diagram illustrating an operation route of a subject vehicle turning right at an intersection.

FIG. 18B is a diagram illustrating an example of a risk map generated based on the operation route illustrated in FIG. 18A.

FIG. 19 is a diagram illustrating a configuration of a traveling environment generation device according to a third embodiment.

FIG. 20 is a diagram illustrating an example of drawing by a blind spot drawing unit.

### DETAILED DESCRIPTION

Embodiments of the present invention will now be described with reference to the drawings.

### First Embodiment

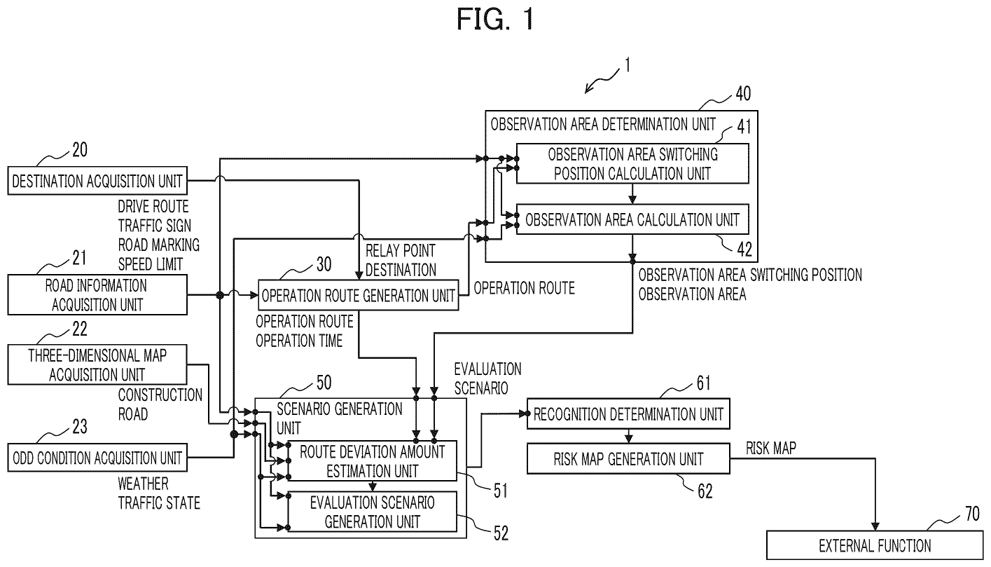

FIG. 1 is a diagram illustrating a configuration of a blind spot estimation device 1 according to the first embodiment. The blind spot estimation device 1 illustrated in FIG. 1 sets an observation area, and estimates a blind spot in the observation area of a vehicle that performs autonomous driving based on data acquired by sensing the observation area by a sensor. For example, the blind spot estimation device 1 is installed in a computer, and reads ODD conditions including also destination information, road information, a three-dimensional map, and vehicle information of an autonomous driving vehicle stored in a storage device to estimate the blind spot. Then, the blind spot estimation device 1 generates a risk map indicating the blind spot, and outputs the generated risk map to an external function 70. Hereinafter, an autonomous driving vehicle as a target of blind spot estimation is referred to as a subject vehicle.

The blind spot estimation device 1 includes a destination acquisition unit 20, a road information acquisition unit 21, a three-dimensional map acquisition unit 22, an ODD condition acquisition unit 23, an operation route generation unit 30, an observation area determination unit 40, a scenario generation unit 50, a recognition determination unit 61, and a risk map generation unit 62.

The blind spot estimation device 1 is provided with, for example, a CPU, a GPU, a RAM, a ROM, and the like, and configured to expand a predetermined program stored in the ROM in the RAM and execute it with the CPU, thereby achieving these functional units. A part of or all the functions of the blind spot estimation device 1 may be achieved using hardware, such as FPGA and ASIC.

The destination acquisition unit 20 acquires destination information, and output it to the operation route generation unit 30. The destination information is information indicating to which position an autonomous driving vehicle travels, and expressed by, for example, a latitude, a longitude, and an altitude. While the destination acquisition unit 20 is configured to acquire the destination information by accepting an input of the destination information in this embodiment, the destination acquisition unit 20 may read the destination information preliminarily stored in a storage medium or the like. For example, managing a place name and building information by preliminarily associating with the latitude, the longitude, and the altitude allows the destination acquisition unit 20 to acquire the latitude, the longitude, and the altitude from input information even when the place name or the building information is input.

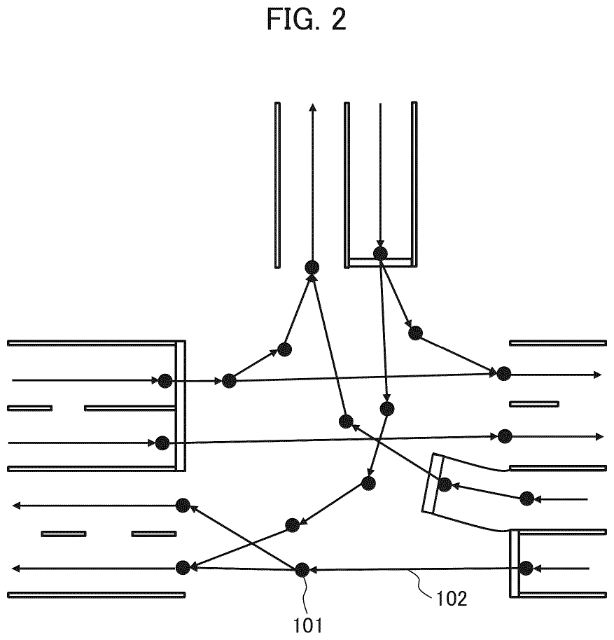

The road information acquisition unit 21 acquires road information, and outputs it to the operation route generation unit 30, the observation area determination unit 40, and the scenario generation unit 50. The road information acquisition unit 21 is configured to acquire the road information by reading the road information preliminarily stored in a storage medium or the like, but not limited to this. FIG. 2 is a diagram for describing the road information. The road information includes, as illustrated in FIG. 2, for example, road network information configured to include edges 102 indicating travel routes (drive routes) of vehicles and nodes 101 coupling the edges 102. The road information also includes information on roadway area and sidewalk area, information on road marking, feature information, such as a traffic sign 109 and a traffic light 110, and the like. FIG. 2 is an example of the road information, and is road network information of a T-junction at which a road having one lane on one side joins a road having two lanes on one side. Position information of the nodes 101 and the edges 102 included in the road information may be expressed by the latitude, the longitude, and the altitude, or may be expressed by an orthogonal coordinate system having a latitude, a longitude, and an altitude at any point as a reference. When the orthogonal coordinate system is used, for example, the orthogonal coordinate system can be set such that the latitude corresponds to a Y-axis direction, the longitude corresponds to an X-axis direction, and the altitude corresponds to a Z-axis direction. The nodes 101 and the edges 102 are each provided with an identifiable ID.

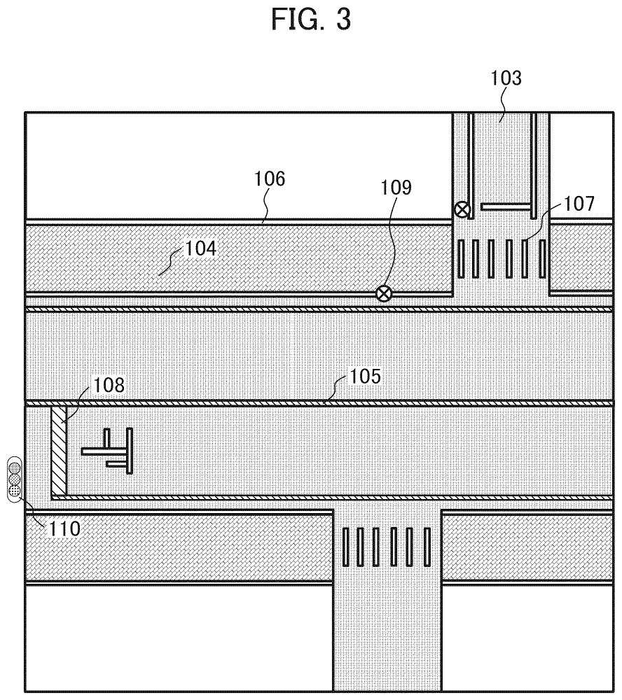

The three-dimensional map acquisition unit 22 acquires a three-dimensional map, and outputs it to the scenario generation unit 50. The three-dimensional map acquisition unit 22 is configured to acquire the three-dimensional map by reading the three-dimensional map preliminarily stored in a storage medium or the like, but not limited to this. FIG. 3 is a diagram for describing the three-dimensional map. The three-dimensional map may include, in addition to a three-dimensional model of an environment in which an autonomous driving vehicle travels, a roadway area 103, a sidewalk area 104, road markings (a division line 105 inside the roadway, a division line 106 of the sidewalk area, a crosswalk 107, a stop line 108, and the like), and feature information, such as a traffic sign 109 and a traffic light 110 illustrated in FIG. 3. Position information on the three-dimensional map may be expressed by the latitude, the longitude, and the altitude similarly to the position information of the node 101 and the edge 102 included in the road information, or may be expressed by an orthogonal coordinate system having a latitude, a longitude, and an altitude at any point as a reference.

The ODD condition acquisition unit 23 acquires an ODD condition, and outputs it to the scenario generation unit 50. ODD is an abbreviated name of Operational Design Domain. The three-dimensional map acquisition unit 22 is configured to acquire the ODD condition by reading the ODD condition preliminarily stored in a storage medium or the like, but not limited to this. The ODD condition is a condition specific to a designed traveling environment that is a premise for a normal operation of an autonomous driving system, and includes a road condition, a geographical condition, an environmental condition, and the like. The road condition includes a position and a type of an infrastructure sensor 111 available in autonomous driving, positions of a school zone and a bus lane, a type of division line, the number of lanes, a speed limit, presence of lane and sidewalk, and the like. The geographical condition includes, for example, a virtual division line for stopping an autonomous driving vehicle. The environmental condition includes, for example, an environmental condition indicating weather when the autonomous driving vehicle operates and an availability of GNSS. The ODD condition further includes a vehicle size, a performance of a sensor mounted to the vehicle, and a mounting position posture with respect to a vehicle origin of the sensor as vehicle information. Here, the infrastructure sensor 111 is a camera or a LIDAR installed in the proximity of a roadside unit or the like, and means one whose recognition result can be used by the autonomous driving vehicle.

The operation route generation unit 30 calculates an operation route and an operation time to a destination of the vehicle based on the destination information and the road information. The operation route generation unit 30 outputs operation route information of the calculated operation route, operation time, and the like to the observation area determination unit 40 and the scenario generation unit 50. As a start point of the operation route, a current position of the subject vehicle may be used, or a set position may be used.

The observation area determination unit 40 includes an observation area switching position calculation unit 41 and an observation area calculation unit 42. The observation area switching position calculation unit 41 calculates an observation area switching position at which the observation area is switched from a first observation area to a second observation area when the operation route intersects with a travel route of other moving body based on the operation route and the road information. For example, as described later, the observation area switching position calculation unit 41 calculates the observation area switching position on the basis of the operation route and a position of an intersection point with a lane on which the other vehicle travels. The observation area calculation unit 42 calculates the second observation area corresponding to the observation area switching position on the basis of the operation route, the road information, and the observation area switching position. The observation area determination unit 40 outputs the calculated observation area switching position and second observation area to the scenario generation unit 50. The first observation area is, for example, an observation area when the subject vehicle travels in a straight line, and the second observation area is, for example, an observation area when the subject vehicle turns right or left.

The scenario generation unit 50 includes a route deviation amount estimation unit 51 and an evaluation scenario generation unit 52. The route deviation amount estimation unit 51 calculates an amount of deviation from a target route generated when the subject vehicle travels on the operation route. The evaluation scenario generation unit 52 generates an evaluation scenario for evaluating a blind spot viewed from the subject vehicle based on the calculated deviation amount, the operation route, the road information, and the ODD condition. At this time, the evaluation scenario generation unit 52 generates a plurality of evaluation scenarios different in environmental condition (for example, weather and a traveling time of day) included in the ODD conditions for the operation route. The generated evaluation scenarios are output to the recognition determination unit 61.

The recognition determination unit 61 simulates a sensing of the second observation area by the sensor mounted to the subject vehicle for each of the generated evaluation scenarios, thereby acquiring sensing data. Then, the recognition determination unit 61 determines a success or failure of recognition of other moving body positioned in the second observation area based on the sensing data. The risk map generation unit 62 aggregates the results of recognition success/failure of the other moving body in the second observation area for the plurality of evaluation scenarios, and generates a risk map indicating the blind spot in the second observation area superimposed on the second observation area. The generated risk map is output to the external function 70.

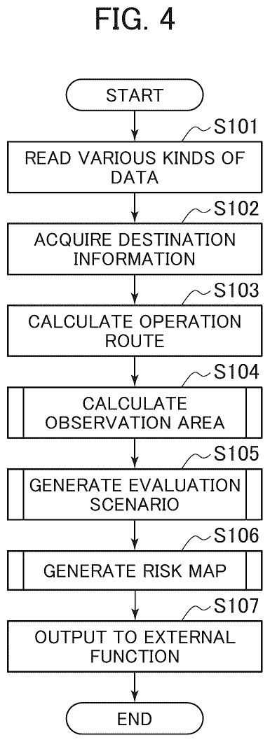

Next, a process performed by the blind spot estimation device 1 is described by referring to FIG. 4. FIG. 4 is a diagram illustrating a flowchart of the process by the blind spot estimation device 1. In this embodiment, the blind spot generated when the subject vehicle travels from an autonomous driving start position to a destination is estimated by a simulator before traveling by autonomous driving.

In Step S101, the road information acquisition unit 21, the three-dimensional map acquisition unit 22, and the ODD condition acquisition unit 23 read various kinds of data, specifically the road information, the three-dimensional map, and the ODD condition, respectively from the storage device. In Step S102, the destination acquisition unit 20 acquires the destination information. The order of Step S101 and Step S102 is not limited thereto, and these steps may be performed as one step.

In Step S103, the operation route generation unit 30 calculates the operation route from the autonomous driving start position to the destination. The operation route is expressed using the nodes and the edges included in the road information as illustrated in FIG. 2. The nodes and the edges to be passed can be obtained, for example, using Dijkstra method having a length of the edge as a cost (weight).

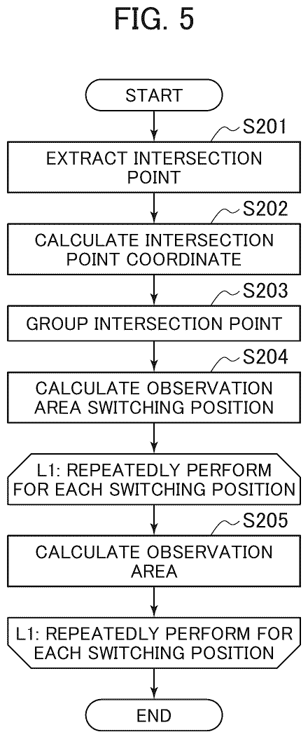

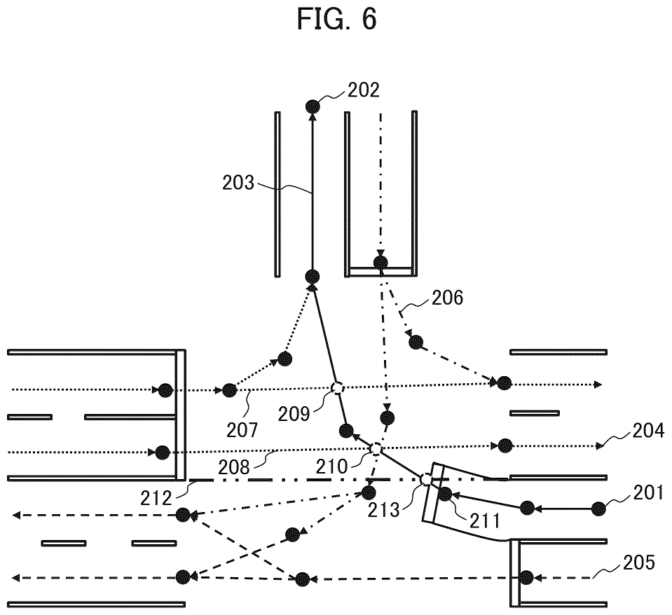

In Step S104, the observation area determination unit 40 calculates the observation area switching position and the second observation area. The second observation area is calculated for each observation area switching position as described later. Step S104 is described in detail using FIG. 5 and FIG. 6. FIG. 5 is a diagram illustrating a flowchart of Step S104. FIG. 6 is a diagram illustrating an example of the road information and the operation route. In FIG. 6, an edge 203 of a solid line connecting from a node 201 to a node 202 and nodes represent the operation route. Meanwhile, an edge 204, an edge 205, and an edge 206 of dashed lines represent the road information. The edge 204 is an opposite route on which an oncoming car travels, the edge 205 is a parallel route on which a vehicle traveling side by side with the subject vehicle travels, and the edge 206 is another route that is not the opposite route or the parallel route. The operation route of FIG. 6 indicates a route of the subject vehicle turning right from a road having two lanes on one side to a road having one lane on one side at a T-junction similar to FIG. 2.

In Step S201 of FIG. 5, the observation area switching position calculation unit 41 extracts an intersection point of the edge included in the road information and the edge of the operation route. In the case of FIG. 6, two edges included in the edge 204, that is, an edge 207 representing a lane on the center side and an edge 208 representing a lane on the outside are extracted as edges intersecting with the operation route of the subject vehicle. The intersecting edge can be extracted by, for example, detecting intersection of straight line segments (edges) on a two-dimensional coordinate. IDs of the extracted edges are recorded in a pair. While the nodes and the edges representing the travel route of the vehicle are assumed in the description of FIG. 6, also in a case where nodes and edges representing a travel route of a pedestrian and a travel route of a bicycle are included in the road information, intersection points are extracted in the same manner as described later.

In Step S202 of FIG. 5, the observation area switching position calculation unit 41 calculates a position of intersection point of the extracted edge and the operation route. The position of intersection point is calculated, for example, as a coordinate of an intersection point of straight line segments on a two-dimensional coordinate. At this time, with only the two-dimensional information, a position of an intersection point of an overpass and a road on the ground, which actually do not intersect with one another, is possibly calculated, and therefore, for example, a process of making the intersection point invalid when an altitude difference between the intersecting edges is 2 m or more is performed based on altitude information included in the edges.

In Step S203 of FIG. 5, the observation area switching position calculation unit 41 performs grouping of the intersection points in which the positions of the intersection points are calculated in Step S202. The grouping is performed for making a group of travel routes of other moving bodies to be integrally confirmed when the subject vehicle turns right or turns left along the operation route. The grouping is specifically a process for putting the intersection points having the same type of the travel route indicated by the edge corresponding to the intersection point and the same road on which the travel route is positioned together in one group. The type of the travel route includes, for example, the travel route of vehicle, the travel route of pedestrian, and the travel route of bicycle. In the example of FIG. 6, since the edge 207 corresponding to an intersection point 209 and the edge 208 corresponding to an intersection point 210 have the same type of travel route of the travel route of vehicle and the same road on which the route is positioned, the intersection point 209 and the intersection point 210 are grouped in the same group.

In Step S204 of FIG. 5, the observation area switching position calculation unit 41 calculates the observation area switching position for each group of the intersection point based on the grouping result of Step S203. For example, the observation area switching position calculation unit 41 calculates a position going back the operation route from a position of an intersection point that the subject vehicle is assumed to pass through at first among the intersection points included in the same group by an amount of a predetermined distance (offset) as the observation area switching position. In the case of FIG. 6, among the intersection point 209 and the intersection point 210 included in the same group, the intersection point that the subject vehicle is assumed to pass through at first is the intersection point 210. Therefore, the observation area switching position calculation unit 41 calculates a position 211 going back the operation route from the intersection point 210 by an amount of a preliminarily set distance as the observation area switching position.

The method for calculating the observation area switching position is not limited to this. For example, as another method, a method of calculating the observation area switching position on the basis of a boundary between lanes can be used. For example, as illustrated in FIG. 6, when the subject vehicle turns right, the observation area switching position calculation unit 41 calculates a position of an intersection point 213 of a boundary 212 between a subject lane and an oncoming lane and the edge 203 representing the operation route as the observation area switching position. The method using offset has an advantage that the observation area switching position can be calculate even at a position where the boundary between the subject lane and the oncoming lane is unknown. In contrast, in the use of the boundary between the lanes, there is an advantage that since a position of a road end of the oncoming lane can be used as the observation area switching position, the second observation area set with the observation area switching position as a starting point is more optimized as described later. Hereinafter, in Step S204, the offset is used to calculate the observation area switching position.

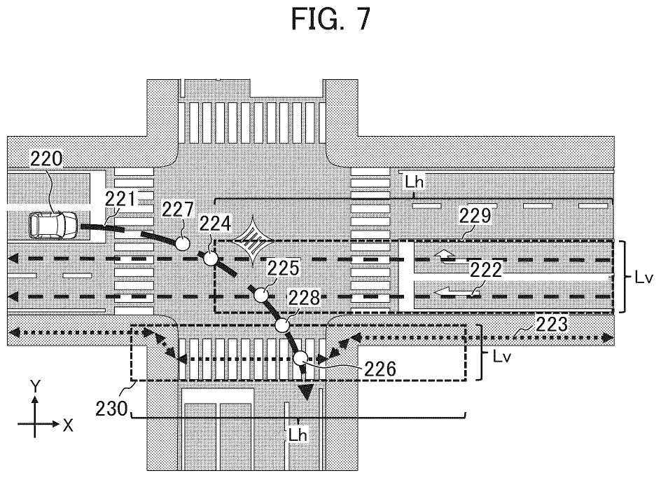

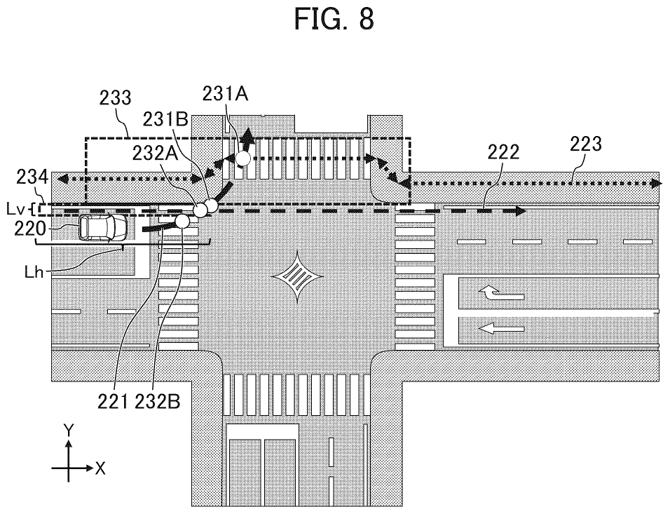

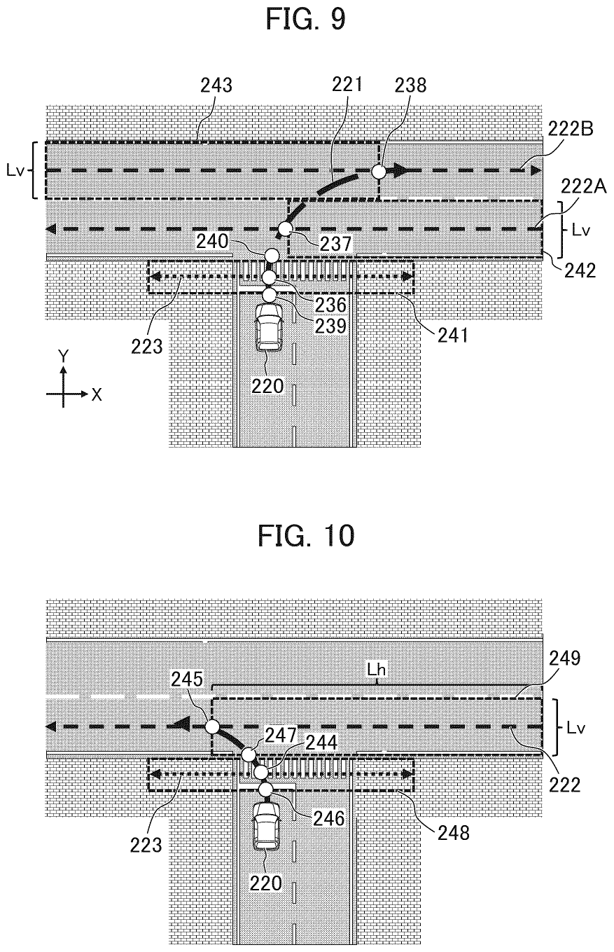

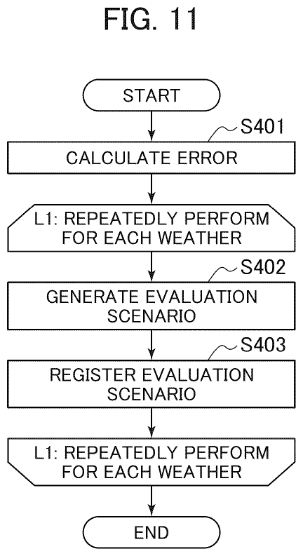

In Step S205 of FIG. 5, the observation area calculation unit 42 calculates the second observation area for each of the observation area switching positions calculated in Step S204. Various situations (right turn and left turn at an intersection, right turn and left turn at a T-junction without a traffic light) of Step S205 are described in detail using FIG. 7, FIG. 8, FIG. 9, and FIG. 10. In FIGS. 7 to 10, edges and nodes representing the operation route and the road information are omitted, and each route is represented by one line.

FIG. 7 is a diagram for describing the second observation area in a case of turning right at an intersection, and illustrates a situation in which a subject vehicle 220 turns right at the intersection along an operation route 221. Here, dashed lines 222 represent travel routes of other vehicles traveling on oncoming lanes, and intersect with the operation route 221 of the subject vehicle 220 at an intersection point 224 and an intersection point 225. A dashed line 223 represents a travel route of a pedestrian, and intersects with the operation route 221 of the subject vehicle at an intersection point 226. In the case of FIG. 7, in Step S203, the intersection point 224 and the intersection point 225 are grouped in one group, and the intersection point 226 is grouped in another group. Then, in Step S204, an observation area switching position 227 is calculated for the group of the intersection point 224 and the intersection point 225, and an observation area switching position 228 is calculated for the group of the intersection point 226. Under such a premise, in Step S205, a second observation area 229 corresponding to the observation area switching position 227 and a second observation area 230 corresponding to the observation area switching position 228 are calculated. In the description of FIG. 7, a direction parallel to the travel route 222 of the other vehicle is an X-axis direction, and a direction perpendicular to the travel route 222 of the other vehicle is a Y-axis direction. In the description, the second observation areas 229 and 230 have rectangular shapes, and a width in the Y-axis direction is referred to as a vertical width Lv and a width in the X-axis direction is referred to as a horizontal width Lh.

The second observation area 229 is set such that the whole width of the oncoming lane is included in the second observation area 229, and the second observation area 229 is set so as to include a range in an X-axis positive direction side from the position of the intersection point 224 which is in the closest side on the operation route of the subject vehicle among the intersection points (224, 225) of the group corresponding to the observation area switching position 227. The vertical width Lv of the second observation area 229 is, for example, a sum of the widths of the oncoming lanes on which the travel routes 222 used for extracting the intersection points 224 and 225 are positioned. The horizontal width Lh of the second observation area 229 is obtained by a formula (1).

$$\begin{matrix}[ Math . 1 ] & \\ {L}_{h} = {v}_{max} * {t}_{motion} + {v}_{max} * {t}_{sensor} + {v}_{max} * {t}_{recog} & ( 1 )\end{matrix}$$

Here, Lₕ is the horizontal width [m], vₘₐₓ is an upper limit speed [m/s] of the lane intersecting with the operation route of the subject vehicle, tₘₒₜᵢₒₙ is a time [s] from passing through the observation area switching position 227 to passing through the second observation area 229, tₛₑₙₛₒᵣ is an acquisition cycle [s] of sensor data used for observation, and t_{recog} is a processing time [s] of object recognition.

Next, the second observation area 230 is described. The second observation area 230 is set to have the intersection point 226 at the center of the horizontal width Lh. The horizontal width of the second observation area 230 is obtained by the formula (1). At this time, vₘₐₓ is a speed [m/s] assumed when a pedestrian or a bicycle travels. The vertical width Lv of the second observation area 230 is set such that an area of the crosswalk is included in the second observation area 230 with the observation area switching position 228 being as a starting point.

FIG. 8 is a diagram for describing the second observation area in a case of turning left at an intersection, and illustrates a situation in which the subject vehicle 220 turns left at the intersection along the operation route 221. Here, a dashed line 222 represents a travel route of other vehicle passing through a side of the subject vehicle, and intersect with the operation route 221 of the subject vehicle 220 at an intersection point 232A. A dashed line 223 represents a travel route of a pedestrian, and intersects with the operation route 221 of the subject vehicle 220 at an intersection point 231A. In the case of FIG. 8, in Step S203, the intersection point 231A is grouped in one group, and the intersection point 232A is grouped in another group. Then, in Step S204, an observation area switching position 231B is calculated for the intersection point 231A, and an observation area switching position 232B is calculated for the group of the intersection point 232A.

Under such a premise, in Step S205, a second observation area 233 corresponding to the observation area switching position 231B and a second observation area 234 corresponding to the observation area switching position 232B are calculated. Since the calculation method of the second observation area 233 is same as that of the observation area 230 of FIG. 7, here, a calculation method of the second observation area 234 is described. In the description of FIG. 8, a direction parallel to the travel route 222 of the other vehicle is an X-axis direction (first direction), and a direction perpendicular to the travel route 222 of the other vehicle is a Y-axis direction. The second observation area 234 has a rectangular shape extending from the position 232A of the intersection point toward an X-axis direction negative side. In the second observation area 234, a vertical width Lv (width in the Y-axis direction) of the second observation area 234 is set to a width from a position in the subject vehicle left side to a road end. The position in the subject vehicle left side is calculated on the basis of the position of the subject vehicle and the width of the subject vehicle. A horizontal width Lh (width in the X-axis direction) of a second observation area 234 is obtained by the formula (1).

FIG. 9 is a diagram for describing the second observation area in a case of turning right at a T-junction without a traffic light, and illustrates a situation in which the subject vehicle 220 turns right at the T-junction without a traffic light along the operation route 221. Here, a dashed line 222A represents a travel route of other vehicle on a lane that the subject vehicle passes through when turning right, and intersect with the operation route 221 of the subject vehicle 220 at an intersection point 237. A dashed line 222B represents a travel route of other vehicle on a lane that the subject vehicle enters by turning right, and intersects with the operation route 221 of the subject vehicle 220 at an intersection point 238. A dashed line 223 represents a travel route of a pedestrian, and intersects with the operation route 221 of the subject vehicle 220 at an intersection point 236. In the case of FIG. 9, in Step S203, the intersection point 237 and the intersection point 238 are grouped in one group because they are same in road on which the travel route is positioned and type of the travel route, and the intersection point 236 is grouped in another group. Then, in Step S204, an observation area switching position 240 is calculated for the group of the intersection point 237 and the intersection point 238, and an observation area switching position 239 is calculated for the group of the intersection point 236. Under such a premise, in Step S205, second observation areas 242 and 243 corresponding to the observation area switching position 240 and a second observation area 241 corresponding to the observation area switching position 239 are calculated. Since the range calculation method of the second observation area 241 is the same as that of the second observation area 230 of FIG. 7, here, a calculation method of the second observation areas 242 and 243 is described. In the description of FIG. 9, a direction parallel to the travel route 222A of the other vehicle is an X-axis direction, and a direction perpendicular to the travel route 222A of the other vehicle is a Y-axis direction. In the description, the second observation areas 242 and 243 have rectangular shapes, and a width in the Y-axis direction is referred to as a vertical width Lv and a width in the X-axis direction is referred to as a horizontal width Lh.

When the travel routes used for extracting the intersection points have only the same direction in the same group of the intersection points like the intersection points 224 and 225 illustrated in FIG. 7, an observation area calculation unit 42 calculates one type of the second observation area for one observation area switching position like the second observation area 229 corresponding to the observation area switching position 227 of FIG. 7. In contrast, when the travel routes used for extracting the intersection points have different directions in the same group of the intersection points like the intersection points 237 and 238 illustrated in FIG. 9, the second observation area is calculated for each type of the direction of the travel route for one observation area switching position like the second observation areas 242 and 243 corresponding to the observation area switching position 240 of FIG. 9.

The second observation area 242 is calculated as a range going back the travel route 222A used for extracting the intersection point 237 from the intersection point 237 by the horizontal width Lh (not illustrated). The horizontal width Lh of the second observation area 242 is obtained by the formula (1). The vertical width Lv of the second observation area 242 is set to a width of the lane indicated by the travel route 222A used for extracting the intersection point 237.

The second observation area 243 is calculated as a range going back the travel route 222B used for extracting the intersection point 238 from the intersection point 238 by the horizontal width Lh (not illustrated). The horizontal width Lh of the second observation area 243 is obtained by the formula (1). The vertical width Lv of the second observation area 243 is set to a width of the lane indicated by the travel route 222B used for extracting the intersection point 238. Since the second observation areas 242 and 243 correspond to the observation area switching position 240, switching to the second observation areas 242 and 243 is performed when the subject vehicle reaches the observation area switching position 240. The second observation areas 242 and 243 are achieved by a plurality of sensors, a 360-degree LiDAR, or the like.

FIG. 10 is a diagram for describing the second observation area in a case of turning left at a T-junction without a traffic light, and illustrates a situation in which the subject vehicle 220 turns left at the T-junction without a traffic light along the operation route 221. Here, a dashed line 222 represents a travel route of other vehicle on a lane that the subject vehicle enters by turning left, and intersects with the operation route 221 of the subject vehicle 220 at an intersection point 245. A dashed line 223 represents a travel route of a pedestrian, and intersects with the operation route 221 of the subject vehicle 220 at an intersection point 244. In the case of FIG. 10, in Step S203, the intersection point 244 is grouped in one group, and the intersection point 245 is grouped in another group. Then, in Step S204, an observation area switching position 246 is calculated for the group of the intersection point 244, and an observation area switching position 247 is calculated for the group of the intersection point 245. Under such a premise, in Step S205, a second observation area 248 corresponding to the observation area switching position 246 and a second observation area 249 corresponding to the observation area switching position 247 are calculated. Since the calculation method of the second observation area 248 is the same as that of the second observation area 230 of FIG. 7, here, a calculation method of the second observation area 249 is described.

The second observation area 249 is calculated as a range going back the travel route 222 used for extracting the intersection point 245 from the intersection point 245 by the horizontal width Lh. The horizontal width Lh of the second observation area 249 is obtained by the formula (1). The vertical width Lv of a second observation area 249 is set to a width of the lane indicated by the travel route 222 used for extracting the intersection point 245.

The vertical width of the second observation area 249 is set to a width of the oncoming lane used for calculating the intersection point 245 with the operation route of the subject vehicle corresponding to the observation area switching position 247. Next, a calculation method of the horizontal width of the second observation area 249 is described. For the horizontal width of the second observation area 249, a value obtained by (1) with respect to a rear side in a traveling direction of the oncoming lane is used with the position 245 of the intersection point being as a starting point.

The second observation area calculated in Step S104 is recorded together with the observation area switching position. The blind spot estimation device 1 repeatedly performs Step S205 of FIG. 5 for each of the observation area switching position, then ends Step S104 of FIG. 4, and proceeds to Step S105 of FIG. 4.

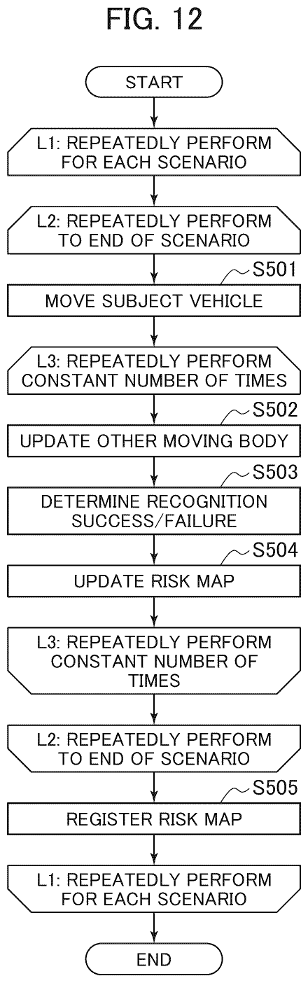

In Step S105 of FIG. 4, the scenario generation unit 50 generates the evaluation scenario. Step S105 is described in detail by referring to FIG. 11. FIG. 11 is a diagram illustrating a flowchart of Step S105. Step S105 includes Steps S401 to S403.

In Step S401, the route deviation amount estimation unit 51 calculates a deviation amount and a misorientation amount of the subject vehicle with respect to the operation route generated when the autonomous driving vehicle travels on a set operation route. In this embodiment, the deviation amount and the misorientation amount are calculated on the basis of positional data of the vehicle acquired when the autonomous driving of the vehicle in a target environment is reproduced by an autonomous driving simulator, but may be calculated on the basis of positional data acquired when a vehicle is actually traveled along the operation route. The deviation amount and the misorientation amount are calculated, for example, for each of the edges constituting the operation route. The deviation amount is an amount indicating how much a vehicle during traveling by autonomous driving has deviated from the operation route. The route deviation amount estimation unit 51 calculates, for example, a perpendicular distance between an edge and a position of the vehicle at a time at which the vehicle is assumed to pass through the edge as the deviation amount. The misorientation amount is an amount of difference between a direction of an edge and a direction of a vehicle at a time at which the vehicle is assumed to pass through the edge. The route deviation amount estimation unit 51, for example, acquires the direction of the edge and the direction of the vehicle as angles, and calculates an absolute value of the difference between these angles as the misorientation amount. Variances of the deviation amount and the misorientation amount are calculated. The values of variance calculated here are used as a position error and an orientation error of the subject vehicle assumed when the autonomous driving vehicle travels each edge of the operation route.

After Step S401, Steps S402 and S403 are repeatedly performed for each weather that is one of the environmental conditions described in the ODD condition. In Step S402, the evaluation scenario generation unit 52 generates the evaluation scenario. The evaluation scenario is a scenario for estimating the blind spot viewed from the autonomous driving vehicle and generating the risk map. The evaluation scenario includes the operation route and the error assumed in the operation of the autonomous driving vehicle, weather, the sensor mounted to the autonomous driving vehicle and the mounting position posture, and information on the pair of the second observation area and the observation area switching position associated with the operation route of the autonomous driving vehicle. Here, the weather includes those affecting the sensor, for example, sunny, rainy, cloudy, snowy, and foggy. In Step S403, the evaluation scenario generated in Step S402 is stored in the storage device. Thus, the evaluation scenario is generated for each weather. The reason why the evaluation scenario is generated for each weather is that the observation range of the sensor and an object recognition rate by the recognition function significantly change depending on the weather. After repeatedly performing Steps S402 and S403 of FIG. 11 for each weather, the blind spot estimation device 1 ends Step S105 of FIG. 4, and proceeds to Step S106 of FIG. 4.

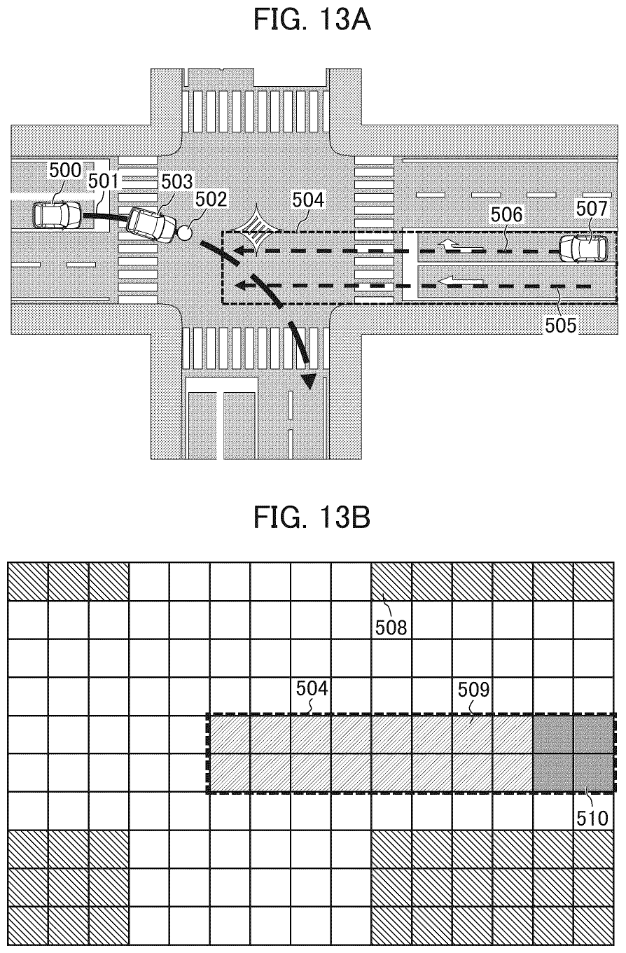

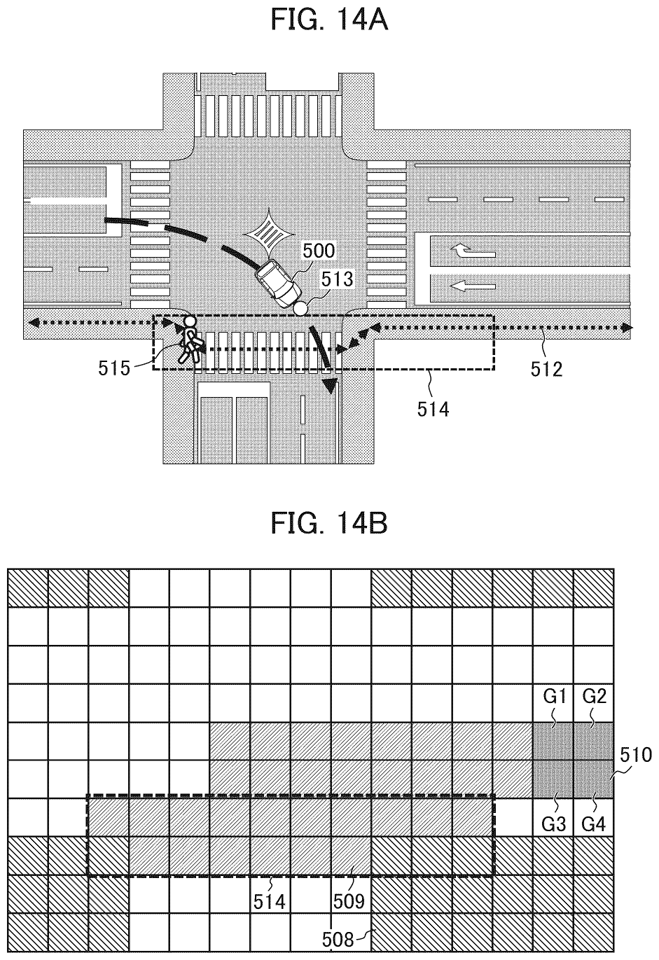

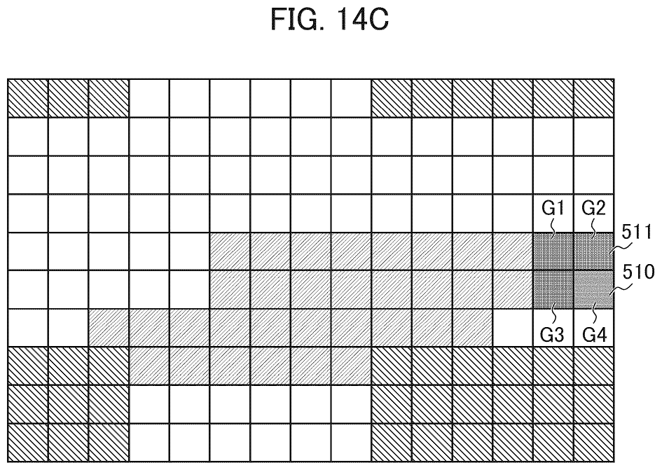

In Step S106, the recognition determination unit 61 simulates a sensing of the second observation area by the sensor mounted to the vehicle, and determines the success or failure of recognition of other moving body positioned in the second observation area. Then, the risk map generation unit 62 aggregates the results of recognition success/failure of the other moving body in the second observation area for the plurality of evaluation scenarios, and generates a risk map indicating the blind spot in the second observation area superimposed on the second observation area. Step S106 is described in detail by referring to FIG. 12. FIG. 12 is a diagram illustrating a flowchart of Step S106. Step S106 includes Steps S501 to S505. The blind spot estimation device 1 performs Steps S501 to S505 for each observation area switching position included in an evaluation scenario for each of the evaluation scenarios. In this embodiment, Step S106 is described with an assumption of the evaluation scenario generated for the operation route of turning right at an intersection similar to FIG. 7. Note that the operation route of turning right at an intersection exemplified here includes two observation area switching positions, and Steps S501 to S505 performed for each observation area switching position are described using FIG. 13A and FIG. 14A illustrating the operation routes with the respective observation area switching positions.

FIG. 13A is a diagram illustrating a first observation area switching position and a second observation area in a case of turning right at an intersection. In Step S501, as illustrated in FIG. 13A, the recognition determination unit 61 moves a subject vehicle 500 to an observation area switching position 502. At this time, when reaching the observation area switching position 502 is determined, the observation area is switched to a second observation area 504.

After Step S501, Steps S502 to S504 are repeatedly performed, and the blind spot in the second observation area 504 is estimated to generate the risk map. The recognition determination unit 61 performs Steps S502 and S503, and the risk map generation unit 62 performs Step S504. FIG. 13B is a diagram illustrating an example of a risk map corresponding to the second observation area 504 illustrated in FIG. 13A. As illustrated in FIG. 13B, the second observation area 504 in the risk map is indicated by a plurality of grids, and each grid is indicated as any of a visible area 509, a blind spot 510, and a conditional blind spot 511 described later. The conditional blind spot 511 indicates an area that conditionally becomes a blind spot, for example, a case of becoming a blind spot depending on the weather, such as a case of becoming a visible area when it is sunny and becoming a blind spot when it is rainy, and a case of becoming a blind spot depending on the operation time.

To generate the risk map as illustrated in FIG. 13B, it is necessary to perform sensor detection on other vehicle present at positions corresponding to the respective grids to acquire sensor data for each grid. Therefore, in Step S502, on a simulation, another vehicle 507 is located at a position of any grid in the second observation area 504. Then, on the simulation, the other vehicle 507 is detected by the sensor mounted to the subject vehicle, and the sensor data is acquired, then the process proceeds to Step S503. The sensor data is assumed to reflect the weather set in the evaluation scenario. For example, when it is rainy or heavy fog, the observation area of LiDAR is restricted, and when it is sunny, the position of sun is calculated on the basis of the operation time set in the scenario to simulate an overexposure of an image.

In Step S503, the recognition determination unit 61 determines the recognition success/failure of a moving body by the sensor using the sensor data generated in Step S502. The recognition determination unit 61 inputs the sensor data to a recognition algorithm assumed in the autonomous driving vehicle, determines the recognition success for the target grid in a case where a moving body (for example, vehicle) of correct type is recognized at the position of the target grid, and determines the recognition failure in the other cases. When a plurality of sensors are mounted, in a case where the moving body of correct type is recognized at the position of the target grid by at least any one of the sensors, the recognition success is determined for the target grid. Here, the recognition success/failure, the sensor data, and a generation condition of the sensor data are mutually associated and recorded. The generation condition of the sensor data means the position and posture of the moving body as the recognition target, the type of the moving body, the weather, the time, and the like. After the determination of the recognition success/failure of the moving body at the target grid, the process proceeds to Step S504.

In Step S504, the risk map generation unit 62 updates the area type of the target grid according to a rule 1 to a rule 8 below. Here, the number of times of validation and the number of times of recognition success recorded at update are used for calculating a recognition success rate (the number of times of recognition success/the number of times of validation) of the target grid.

### (Rule 1)

For the target grid, when the area type before update is an initial value (undetermined), and the recognition success is additionally determined, the area type of the target grid is set to the visible area. Then, 1 is added to each of the number of times of validation and the number of times of recognition success of the target grid.

### (Rule 2)

For the target grid, when the area type before update is the initial value, and the recognition failure is additionally determined, the area type of the target grid is set to the blind spot. Then, 1 is added to the number of times of validation of the target grid.

### (Rule 3)

For the target grid, when the area type before update is the visible area, and the recognition success is additionally determined, the area type of the target grid is left to be the visible area. Then, 1 is added to each of the number of times of validation and the number of times of recognition success of the target grid.

### (Rule 4)

For the target grid, when the area type before update is the visible area, and the recognition failure is additionally determined, the area type of the target grid is set to the conditional blind spot. At this time, the weather, the type of recognition target, and the time at the recognition failure are registered as conditions of the conditional blind spot. Then, 1 is added to the number of times of validation of the target grid.

### (Rule 5)

For the target grid, when the area type before update is the blind spot and the recognition success is additionally determined, the area type of the target grid is set to the conditional blind spot. At this time, the weather, the type of recognition target, and the time at the recognition failure are registered as conditions of the conditional blind spot. Then, 1 is added to each of the number of times of recognition success and the number of times of validation of the target grid.

### (Rule 6)

For the target grid, when the determination result before update is the blind spot and the recognition failure is additionally determined, the area type of the target grid is left to be the blind spot. At this time, the weather, the type of recognition target, and the time at the recognition failure are registered as conditions of the conditional blind spot. Then, 1 is added to the number of times of validation of the target grid.

### (Rule 7)

For the target grid, when the determination result before update is the conditional blind spot, and the recognition success is additionally determined, the area type of the target grid is left to be the conditional blind spot. Then, 1 is added to each of the number of times of validation and the number of times of recognition success of the target grid.

### (Rule 8)

For the target grid, when the determination result before update is the conditional blind spot, and the recognition failure is additionally determined, the area type of the target grid is left to be the conditional blind spot. At this time, the weather, the type of recognition target, and the time at the recognition failure are registered as conditions of the conditional blind spot. Then, 1 is added to the number of times of validation of the target grid.

Steps S502 to S504 described above are repeatedly performed for each of the grids in the second observation area 504, and the sensor data acquisition (Step S502), the recognition success/failure determination (Step S503), and the risk map update (Step S504) are performed for all of the grids in the second observation area 504. In the case of the initial value before update, each of the grids in the second observation area 504 illustrated in FIG. 13B is, for example, determined as a grid of the visible area 509 or the blind spot 510 as illustrated in FIG. 13B according to the rule 1 and the rule 2 described above. As illustrated in FIG. 13B, an area 508 that includes a building or the like but does not include a moving body may be expressed on the risk map.

FIG. 14A is a diagram illustrating a second observation area switching position 513 and a second observation area 514 in a case of turning right at an intersection. FIG. 14B is a diagram illustrating an example of a risk map corresponding to the second observation area 514 illustrated in FIG. 14A. For also the second observation area 514 illustrated in FIG. 14A, the sensor data acquisition (Step S502), the recognition success/failure determination (Step S503), and the risk map update (Step S504) are performed as described above. However, in Step S502, a pedestrian 515 is located as a moving body at the target grid. For the recognition algorithm to which the sensor data is input in Step S503, a model different from the model used for recognizing an automobile, for example, a model specialized in pedestrian recognition may be used.

In the case of the initial value before update, each of the grids in the second observation area 514 illustrated in FIG. 14B is, for example, determined as the visible area 509 as illustrated in FIG. 14B according to the rule 1 in Step S504. The risk map is generated for each operation route, and when the operation route includes a plurality of observation area switching positions, as illustrated in FIG. 14B, a plurality of second observation areas appear on the risk map.

When Steps S502 to S504 are repeatedly performed, the recognition determination unit 61 provides the position error and the orientation error of the subject vehicle calculated in Step S401 to the position and the direction of the subject vehicle as, for example, normally distributed errors every time. Then, the recognition determination unit 61 determines the recognition success/failure of the sensor based on the sensing data observed by the sensor of the subject vehicle at the position and in the direction to which the position error and the orientation error are provided, and this allows calculation of the blind spot viewed from the subject vehicle in the state where the assumed error is provided.

In this embodiment, the case where a moving body is located to correspond to the positions of the respective grids in the second observation area 504 on a simulation and the sensor detection is performed on the located moving body in Step S502 is described, but it is not limited to this. For example, as Step S502, the other vehicle 507 is traveled at an upper limit speed along travel routes 505 and 506 in the second observation area 504 on a simulation, and sensor data during the traveling is acquired. At this time, the position of the other vehicle 507 is associated with the sensor data so as to allow finding the position of the other vehicle 507 at the time when the sensor data is acquired. Then, in Step S503, the sensor data when the other vehicle 507 is at the position of the target grid can be extracted from the sensor data associated with the position of the other vehicle 507 and the recognition success/failure of the moving body can be determined for the target grid on the basis of the extracted sensor data. As illustrated in FIG. 14A, when the moving body is a pedestrian, and the sensor data is acquired while moving the pedestrian, the travel route (a travel route 512 in FIG. 14A) is moved in both directions. The moving speed in this respect is set to a speed appropriate for the pedestrian.

When the generation of the risk map ends for one evaluation scenario, the risk map generated at the time point is registered in association with the scenario in Step S505.

Assume that the risk map illustrated in FIG. 14B is a risk map relative to the evaluation scenario in a case of the weather of rainy and turning right at an intersection. Here, furthermore, assume a risk map relative to an evaluation scenario in which the operation route is the same and the weather is different, that is, an evaluation scenario in a case of the weather of sunny and turning right at an intersection. Since the risk map is generated for each operation route, the risk map relative to the evaluation scenario in the case of the weather of sunny and turning right at an intersection is generated by updating the risk map of FIG. 14B having the same operation route. An example of the risk map updated based on the evaluation scenario in which the operation route is same and the weather is different is illustrated in FIG. 14C. In the risk map in which the weather is rainy illustrated in FIG. 14B, grids G1 to G4 are determined to be the blind spot 510. In contrast, in the case where the weather is sunny, since the observation area of the sensor is expanded, the grids G1 to G3 are additionally determined to be the recognition success in Step S503, and the area type of the grids G1 to G3 is set to the conditional blind spot 511 according to the rule 5 in Step S504.

By the sequence of the processes described above, the blind spot viewed from the subject vehicle is calculated to generate the risk map. While the method of generating the risk map for each scenario is described here, the risk map may be generated by superimposing the blind spot for each evaluation scenario having the same traveling route.

At last, in Step S107, the generated risk map is output to the external function 70.

Note that when it is difficult to distinguish a travel route of pedestrian and a travel route of bicycle due to, for example, a sidewalk partially used as a bicycle track, a bicycle may be assumed as the other moving body instead of the pedestrian.

While the evaluation scenario generation unit 52 generates the evaluation scenario for each weather included in the environmental conditions, for example, the evaluation scenario can be generated for each traveling time of day of the subject vehicle.

### Effects

By performing the sequence of the processes described above, even in an environment including the operation of right/left turn or the like, the observation area can be appropriately set. Then, when the autonomous driving is performed by controlling the vehicle with the vehicle control device according to the operation route, the observation area switching position, and the observation area calculated by the blind spot estimation device 1, the blind spot indicated by the risk map can be, for example, visually confirmed by a human, and when there is any problem, it can be dealt with, for example, by stopping the autonomous driving and switching it to normal driving.

As described above, according to this disclosure, the blind spot in the observation area of the vehicle can be estimated.

### Second Embodiment

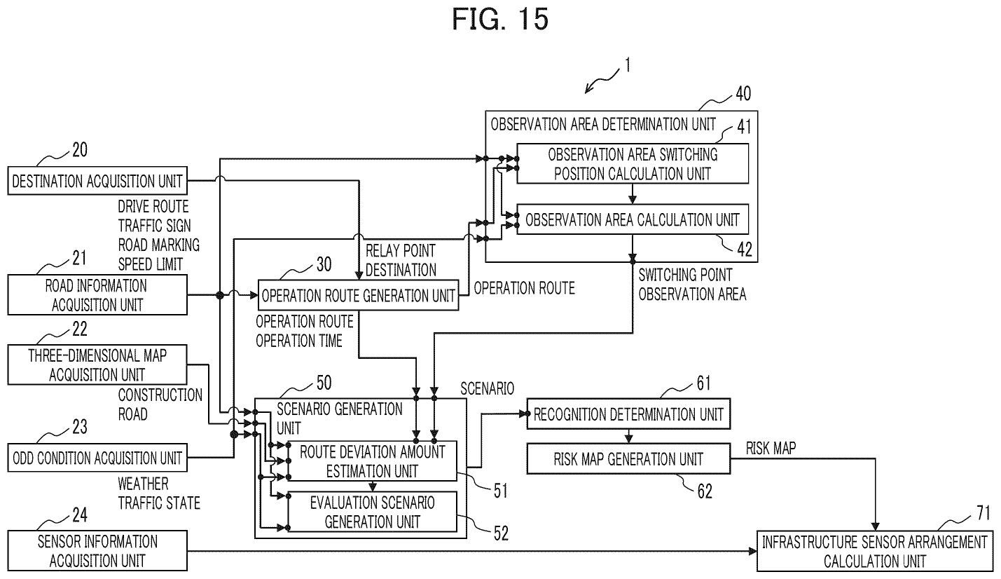

FIG. 15 is a diagram illustrating a configuration of a blind spot estimation device according to a second embodiment. As illustrated in FIG. 15, a blind spot estimation device 1 of this embodiment further includes a sensor information acquisition unit 24 and an infrastructure sensor arrangement calculation unit 71. While the external function 70 of the first embodiment is not included in the blind spot estimation device 1, the infrastructure sensor arrangement calculation unit 71 of this embodiment is included in the blind spot estimation device 1. Since the configuration of the blind spot estimation device 1 is common with that of the first embodiment except the sensor information acquisition unit 24 and the infrastructure sensor arrangement calculation unit 71, the explanation is omitted for the part common with the first embodiment.

The infrastructure sensor is, as described above, a sensor, such as a camera and a LiDAR, installed in an environment, for example, the proximity of a traffic light, a roadside unit, or the like, and is installed in the proximity of an intersection and a place in which a blind spot is easily generated. The autonomous driving vehicle can complement recognition of a blind spot viewed from the subject vehicle by using sensor data acquired by the infrastructure sensor. The infrastructure sensor arrangement calculation unit 71 calculates the arrangement of the infrastructure sensor to minimize the blind spot of the subject vehicle using the risk map obtained in the first embodiment.

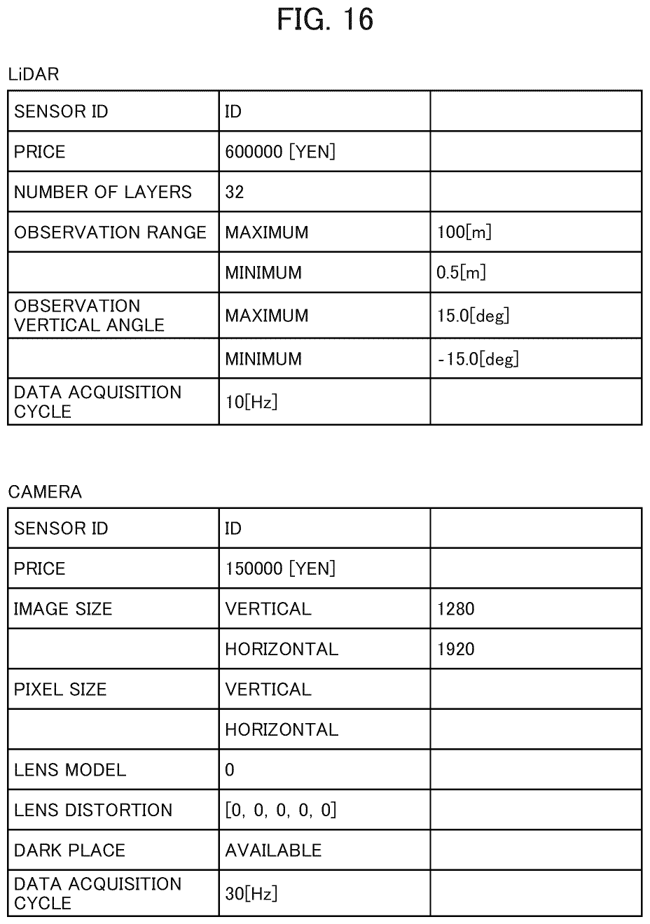

The sensor information acquisition unit 24 acquires sensor information 14 of the infrastructure sensor. FIG. 16 illustrates an example of the sensor information of the infrastructure sensor. The sensor information 14 is information on the infrastructure sensor planned to be installed in the traveling environment, and includes parameters for simulating information that can be acquired by various kinds of infrastructure sensors and a sensor price. The parameters for simulating the information that can be acquired by various kinds of infrastructure sensors include the number of layers, an observation range, an observation vertical angle, a data acquisition cycle, and the like in the case of LiDAR, and include an image size, a pixel size, a lens model, and the like in the case of camera.

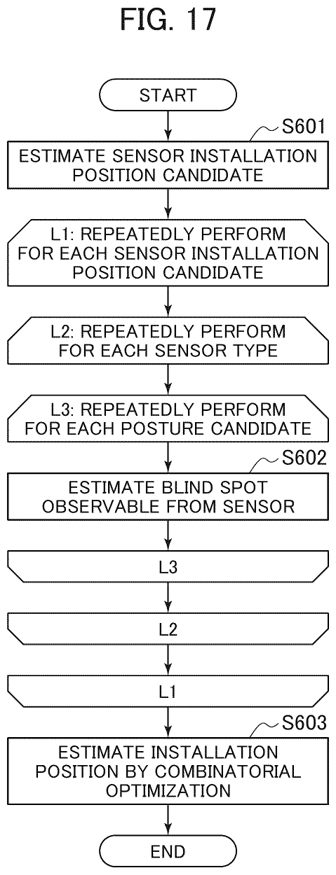

FIG. 17 is a diagram illustrating a flowchart of a process by the infrastructure sensor arrangement calculation unit 71. The infrastructure sensor arrangement calculation unit 71 estimates a candidate of an installation position of the infrastructure sensor in Step S601. In this embodiment, as the candidate of the infrastructure sensor installation position, a position of a traffic sign included in the three-dimensional map is used. In this case, when a LiDAR is used, it is installed at a position of 1.5 m from the ground, and when a camera is used, it is installed so as to face in an obliquely downward direction from an upper portion of the traffic sign.

Next, the infrastructure sensor arrangement calculation unit 71 estimates a blind spot observable by an infrastructure sensor when the infrastructure sensor is installed among the blind spots of the subject vehicle indicated on the risk map in Step S602. The observable blind spot is estimated by, like Step S503 in the flowchart of FIG. 12, setting a model of a moving body, such as a vehicle and a pedestrian, in the blind spot to be verified whether to be observable, generating sensor data that can be acquired by a sensor planned to be installed, and inputting the generated sensor data to a recognition algorithm to be used. At this time, when the blind spot to be verified whether to be observable is set to a conditional blind spot of rain, time (night-time), and the like, the sensor data is generated in combination with the condition. When the blind spot to be verified whether to be observable is set to an ordinary blind spot, the sensor data is generated with the weather condition and the time described in the ODD condition.

The process of Step S602 is repeatedly performed for each of the sensor types and further each of a plurality of postures input as the sensor information 14 for each of all the candidates of the infrastructure sensor installation position. Thus, a plurality of candidates of the installation posture of the sensor planned to be installed are generated for each of all the candidates of the infrastructure sensor installation position. The plurality of posture candidates may be generated in a range of ±10° at every 2° in a pitch direction in the case of LiDAR, and may be generated in a range of ±10° at every 2° in a pitch direction and in a range of ±180° at every 90° in a yaw direction in the case of camera, for example. The combination of the installation position, the installation posture, the sensor type, and the observable blind spot of the infrastructure sensor used for the estimation here is stored for optimization of the infrastructure sensor arrangement. When the ODD condition includes information on an infrastructure sensor already installed in the environment and the blind spot on the generated risk map has been observed, it is used for the estimation of the infrastructure sensor arrangement in Step S603.

Next, the infrastructure sensor arrangement calculation unit 71 estimates the combination of the infrastructure sensor to be installed, the installation position, and the installation posture, that is, the infrastructure sensor arrangement by combinatorial optimization in Step S603. Step S603 estimates a sensor arrangement with which all the blind spots in the target area are eliminated using the information on the observable blind spot obtained for each of the sensor installation positions, the installation postures, and the sensor types calculated in the process of Step S602. In this embodiment, the combination that satisfies the following constraint conditions are calculated as a set covering problem by a greedy algorithm. Since there are known methods for solving the combinatorial optimization problem, please refer to those for details. When an infrastructure sensor has been already installed, it is considered in the optimization to surely install the existing infrastructure sensor, but the price of the existing infrastructure sensor is not added to the sensor price.

### Constraint Condition

### (Condition 1)

All the blind spots have been observed by the number of sensors equal to or more than a set number.

### (Condition 2)

The sum of the prices of sensors to be installed falls within a preliminarily set price.

### (Condition 3)

A plurality of sensors are not arranged at the same sensor installation position.

Here, the set number of sensors is for considering redundancy, and is set because a pedestrian possibly blocks another pedestrian in a case where there is a possibility of including many pedestrians, for example, a school zone. In this embodiment, the setting is made to observe all the blind spots of the subject vehicle with one or more sensors. As the calculation result of the arrangement of the infrastructure sensor, a plurality of arrangements that satisfy the above-described constraints are calculated in some cases. At this time, combinations of a plurality of arrangements, for example, an arrangement in which the sum of the sensor prices becomes minimum, an arrangement in which the number of sensors becomes minimum, and an arrangement in which the sensing multiplicity becomes maximum, and ranges observed when the sensors are arranged are output. Further, due to the small number of the candidates of the infrastructure sensor installation position, the combination that allows observing all the blind spots cannot be calculated in some cases. In this case, a combination of the infrastructure sensor arrangement with which the largest number of the blind spots can be observed and the blind spots left to be not observed is output.

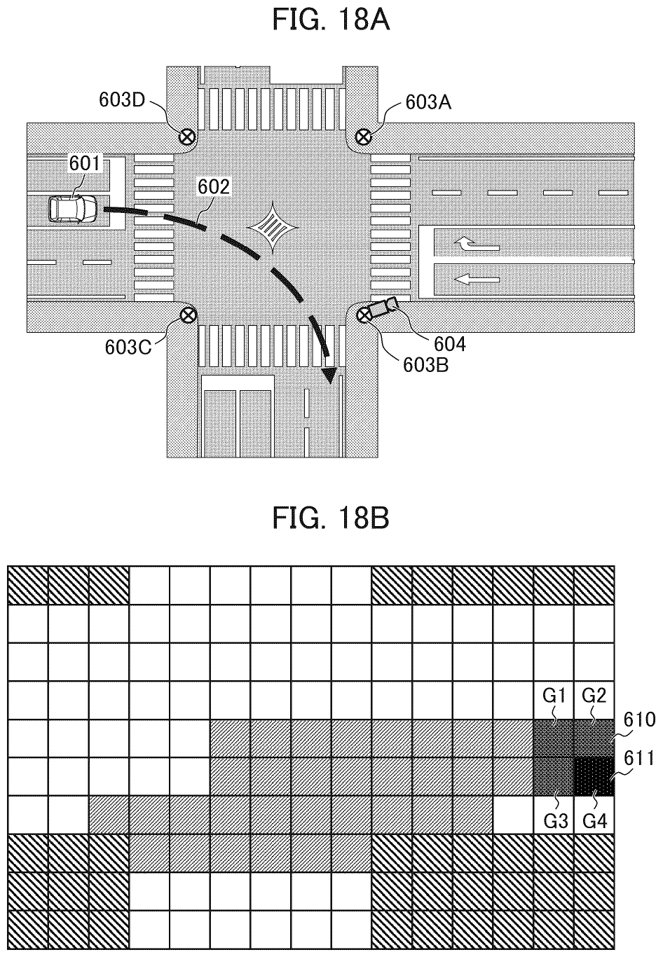

FIG. 18A is a diagram illustrating an operation route 602 of a subject vehicle 601 turning right at an intersection. FIG. 18B is a diagram illustrating an example of a risk map generated for the operation route 602 illustrated in FIG. 18A. On the risk map illustrated in FIG. 18B, grids G1 to G3 are conditional areas 610 that become a blind spot when it is rainy, and a grid G4 is a blind spot 611. As a result of performing Steps S601 to S603 of FIG. 17 based on such a risk map, for example, the sensor is installed at an installation position candidate 603B among installation position candidates 603A to 603D of the infrastructure sensor of FIG. 18A. At this time, since the blind spot is narrow, an infrastructure sensor arrangement result indicating that a low-price camera with a limited observation range is installed to face the area and the sensor price of 150,000 are output.

### Effect

By the sequence of the processes described above, the arrangement of the infrastructure sensor that assists the environment recognition of the autonomous vehicle can be automatically calculated using the generated risk map.

### Third Embodiment

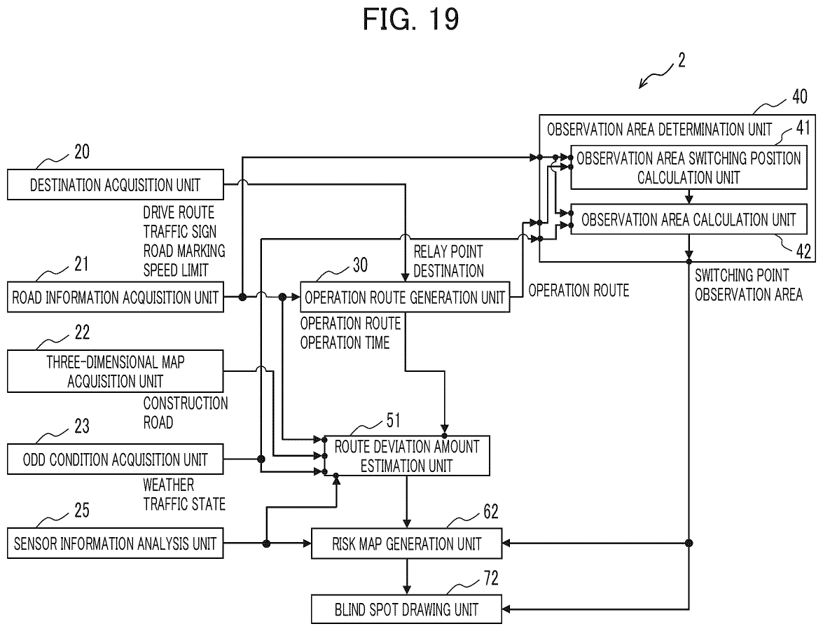

FIG. 19 is a diagram illustrating a configuration of a traveling environment generation device 2 according to the third embodiment. The traveling environment generation device 2 according to the third embodiment estimates a blind spot of a vehicle during actual traveling by autonomous driving of a subject vehicle based on sensor data obtained by sensing an observation area by a sensor mounted to the subject vehicle. This allows, for example, a user to evaluate whether the subject vehicle is actually observing a visible area of a risk map acquired in advance by simulation during traveling. The traveling environment generation device 2 according to the embodiment includes a route deviation amount estimation unit 51 instead of the scenario generation unit 50 of the blind spot estimation device 1 illustrated in FIG. 1, and the recognition determination unit 61 of the blind spot estimation device 1 illustrated in FIG. 1 is removed. Then, the traveling environment generation device 2 has a configuration in which a sensor information analysis unit 25 and a blind spot drawing unit 72 are added to the blind spot estimation device 1 illustrated in FIG. 1. In this embodiment, a difference from the blind spot estimation devices of the first embodiment and the second embodiment is mainly described.

The sensor is mounted to the subject vehicle, and acquires information around the subject vehicle during traveling. The sensor information analysis unit 25 analyzes the information acquired by the sensor. Specifically, the sensor information analysis unit 25 detects a moving body from data acquired from an external recognition sensor mounted to the vehicle. Further, when a sensor, such as a camera, configured to estimate weather is mounted, the weather is estimated, and when a GNSS receiver is mounted, a GNSS reception state is estimated.

The route deviation amount estimation unit 51 calculates not the error (variance) with respect to the edge constituting the operation route in the first and second embodiments, but values of absolute position error and absolute orientation error with respect to the edge. The absolute position error is an absolute value of a perpendicular distance between the position of the subject vehicle and the edge (straight line segment) constituting the operation route. The absolute orientation error is absolute values of a direction of the autonomous driving vehicle on a two-dimensional coordinate and a direction of the edge constituting the operation route on the two-dimensional coordinate.

The risk map generation unit 62 generates a risk map indicating a state of observation of a surrounding environment by the vehicle based on the sensing data by the sensor mounted to the vehicle, for example, information on the moving body detected by the sensor information analysis unit 25. At this time, an occupancy grid map around the subject vehicle is generated using a known method of inverse sensor model or the like. At this time, the state of each grid includes four states of observable, non-observable, occupied by moving body, and occupied by feature.

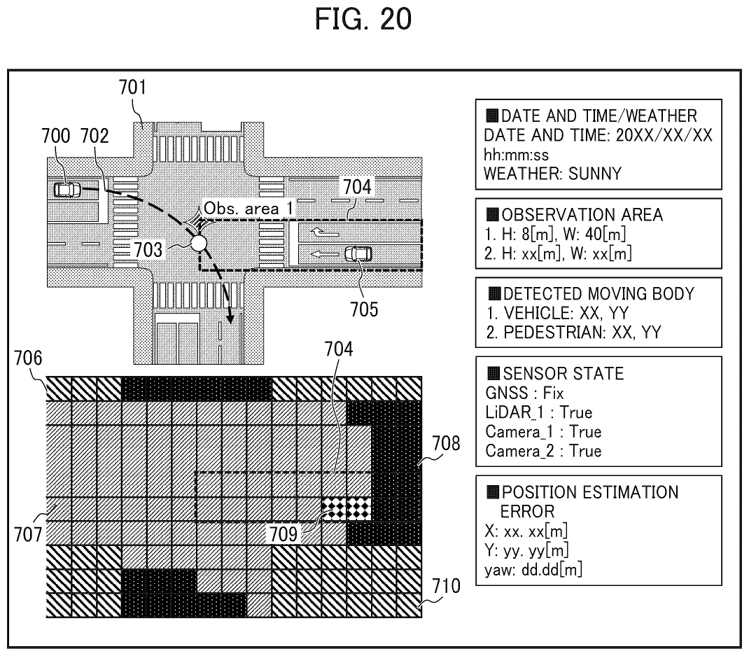

The blind spot drawing unit 72 displays the generated risk map with a second observation area superimposed thereon to the user. FIG. 20 illustrates an example of drawing by the blind spot drawing unit 72. The blind spot drawing unit 72 draws, for example, a subject vehicle position 700, an operation route 702 of the subject vehicle position 700, an observation area switching position 703, a second observation area 704, another vehicle 705 observed by the sensor mounted to the subject vehicle, and the like on a bird's-eye view 701 of the surrounding environment, and presents it to the user. At this time, a number is attached to the second observation area 704 as a label and displayed. Furthermore, the blind spot drawing unit 72 draws an occupancy grid map 706 corresponding to the bird's-eye view 701 of the surrounding environment, and presents it to the user. In the occupancy grid map 706, each of the grids is represented as any of a visible area 707 (observable state) observable from the subject vehicle, a blind spot 708 (non-observable state) viewed from the subject vehicle, a moving body area 709 (state of being occupied by moving body) in which a moving body is present, and a feature area 710 (state of being occupied by feature) occupied by a feature, such as a building. Together with them, the blind spot drawing unit 72 draws date and time/weather, a size of the second observation area, a type and a position of the detected moving body, a state of the sensor mounted to the subject vehicle, and a position error of the subject vehicle with respect to a target route as those indicating the condition and the state of traveling. This allows validation of system operation by confirming the position and the second observation area of the subject vehicle, the blind spot viewed from the subject vehicle, the position of the other moving body, the state of the sensor, and the like.

### Effect

By performing the sequence of the processes described above, whether the required area is observed or not can be verified while the subject vehicle is traveling.

While the embodiments of the present invention are described above, the present invention is not limited to the aforementioned embodiments, and various changes can be made without departing from the scope described in claims. For example, the above-described embodiments describe the present invention in detail, and it is not necessary to include all the described configurations. A configuration of another embodiment can be added to a configuration. In addition, addition, removal, and replacement can be made for a part of a configuration.

What is claimed is:

1. A blind spot estimation device configured to set an observation area and estimate a blind spot in the observation area of a vehicle that performs autonomous driving on the basis of data acquired by sensing the observation area by a sensor, the blind spot estimation device comprising:
an operation route generation unit that calculates an operation route to a destination of the vehicle;
an observation area switching position calculation unit that calculates an observation area switching position at which the observation area is switched from a first observation area to a second observation area when the operation route intersects with a travel route of other moving body;
an observation area calculation unit that calculates the second observation area corresponding to the observation area switching position;
a scenario generation unit that generates a plurality of evaluation scenarios that are different in a predetermined environmental condition for the operation route;
a recognition determination unit that determines a success or failure of recognition of the other moving body positioned in the second observation area by simulating a sensing of the second observation area by a sensor mounted to the vehicle under the environmental condition for each of the evaluation scenarios; and
a risk map generation unit that aggregates results of the success or failure of recognition of the other moving body in the second observation area for the plurality of evaluation scenarios and generates a risk map indicating a blind spot in the second observation area superimposed on the second observation area.

2. The blind spot estimation device according to claim 1, wherein
the observation area switching position calculation unit calculates a position going back the operation route by an amount of a predetermined distance from a position of an intersection point of the operation route and the travel route as the observation area switching position.

3. The blind spot estimation device according to claim 1, wherein
the observation area calculation unit calculates a position of the second observation area in a first direction on the basis of a position of an intersection point of the operation route and the travel route when a direction parallel to the travel route is the first direction, and calculates a width of the second observation area in the first direction on the basis of a moving speed of the other moving body, a time from passing through the observation area switching position to passing through the second observation area, an acquisition cycle of sensor data of the sensor, and a processing time of object recognition.

4. The blind spot estimation device according to claim 1, wherein
when the operation route intersects with each of a plurality of the travel routes and there are a plurality of the intersection points of the operation route and the travel route, the observation area switching position calculation unit divides the plurality of intersection points into groups, and calculates the observation area switching position for each of the groups.

5. The blind spot estimation device according to claim 4, wherein
the travel route includes at least two types of a travel route of a vehicle or a travel route of a pedestrian, and
the observation area switching position calculation unit divides the plurality of intersection points into the groups depending on the type of the travel route intersecting with the operation route.

6. The blind spot estimation device according to claim 4, wherein
the observation area switching position calculation unit calculates a position going back the operation route from a position of the intersection point at which the vehicle is assumed to pass through at first by an amount of a predetermined distance, among the intersection points in the group as the observation area switching position.

7. The blind spot estimation device according to claim 1, further comprising:
a route deviation amount estimation unit that calculates a position error and an orientation error of the vehicle with respect to the operation route, wherein
the recognition determination unit simulates a sensing of the second observation area by the sensor mounted to the vehicle at a position and in a direction to which the position error and the orientation error are given.

8. The blind spot estimation device according to claim 1, wherein
the risk map generation unit indicates the second observation area by a plurality of grids on the risk map, and classifies area types of the respective plurality of grids into a visible area, a blind spot, or a conditional blind spot.

9. The blind spot estimation device according to claim 8, wherein
the visible area indicates an area that the recognition determination unit determines as a recognition success in all of the plurality of evaluation scenarios,
the blind spot indicates an area that the recognition determination unit determines as a recognition failure in all of the plurality of evaluation scenarios, and
the conditional blind spot indicates an area that the recognition determination unit determines as the recognition success in a part of the plurality of evaluation scenarios.

10. The blind spot estimation device according to claim 1, wherein
the environmental condition is a weather or a traveling time of day.

11. The blind spot estimation device according to claim 1, further comprising:
an infrastructure sensor arrangement calculation unit that calculates an arrangement of an infrastructure sensor on the basis of the risk map such that the infrastructure sensor arranged in an environment performs a sensing of the blind spot.

12. A vehicle control device that controls the vehicle according to the operation route, the observation area switching position, and the observation area calculated by the blind spot estimation device according to claim 1.

13. A vehicle including the vehicle control device according to claim 12.

14. A traveling environment generation device configured to set an observation area and estimate a blind spot in the observation area of a vehicle that performs autonomous driving on the basis of data acquired by sensing the observation area by a sensor, the traveling environment generation device comprising:
an operation route generation unit that calculates an operation route to a destination of the vehicle;
an observation area switching position calculation unit that calculates an observation area switching position at which the observation area is switched from a first observation area to a second observation area when the operation route intersects with a travel route of other moving body;
an observation area calculation unit that calculates the second observation area corresponding to the observation area switching position;
a risk map generation unit that generates a risk map indicating a state of observation of a surrounding environment by the vehicle from sensing data by a sensor mounted to the vehicle; and
a blind spot drawing unit that displays the risk map with the second observation area superimposed thereon.

15. The traveling environment generation device according to claim 14, wherein
the blind spot drawing unit displays weather information estimated from the sensing data.
